(19) United States
(12) Patent Application Publication
(10) Pub. No.: US 2015/0224943 A1
(43) Pub. Date: Aug. 13, 2015

(54) TUFTED CARPET FOR AUTOMOTIVE APPLICATIONS

(71) Applicants: James Taylor, Volketswil (CH); Meganathan Meenakshisundaram, Winterthur (CH)

(72) Inventors: James Taylor, Volketswil (CH); Meganathan Meenakshisundaram, Winterthur (CH)

(73) Assignee: AUTONEUM MANAGEMENT AG

(21) Appl. No.: 14/177,364

(22) Filed: Feb. 11, 2014

(51) Int. Cl. B60R 13/08; D05C 17/02

(52) U.S. Cl. CPC B60R 13/0815; D05C 17/026

(57) ABSTRACT

Embodiments of the present invention relate to a tufted carpet. The carpet may include a pile layer configured to be coupled to the cabin via one or more other layers, the pile layer having a bulked continuous filament (BCF) yarn. The BCF yarn may include at least a polypropylene (PP) yarn material with a tenacity between about 2.6 cN/dtex and about 3.2 cN/dtex at an elongation of about 50% to about 70%.

### CROSS REFERENCE TO RELATED APPLICATIONS

This application is a continuation of U.S. application Ser. No. 13/321,496, filed Nov. 18, 2011 and entitled “TUFTED CARPET FOR AUTOMOTIVE APPLICATIONS,” the entire disclosure of which is incorporated herein by reference. U.S. application Ser. No. 13/321,496 is a national phase application under 35 U.S.C. §371 based on International Application No. PCT/EP2010/056700, filed May 17, 2010, which claims the priority of Swiss Patent Application No. 00773/09, filed May 18, 2009, the entire contents of which are hereby incorporated by reference.

### FIELD

The invention relates generally to tufted carpets and more particularly to tufted carpets for automotive applications.

### BACKGROUND

In the automotive industry tufted carpets are used for multiple purposes and in various applications. One such purpose is noise attenuation. Another purpose is an increase of comfort of driving environments. These purposes are achieved by vehicle floor systems, main floors, and deck side trims in trunks, including load floor and parcel shelf.

Those applications can be found in human transport vehicles, like cars or vans, or in lorries. Vehicle floor systems are comprised of several layers: a surface or pile layer, a primary backing layer, a back coating, a substrate and a decoupler. The decoupler contacts a Body-in-White (BIW) and decouples any noise or vibration in the BIW from the passenger cabin. The decoupler is generally comprised of foam and fibrous material. The substrate may be an absorber or a barrier and may be comprised of a combination of materials, fibers and foams to form a controlled porosity substrate. The back coating may securely retain the tufts in the primary backing layer. Alternatively, a thermal process in which the tufts and the primary backing layer are securely bonded together by melting may remove the need for the back coating. The primary backing layer may be comprised of a woven or nonwoven material. The pile layer may be comprised of the tufts. The pile layer and the primary backing layer may comprise the carpet, whereas the back coating may comprise the intersectional layer to the substrate.

Deck side trims may also be found in human transport vehicles, like cars or vans, or in lorries. Deck side trims are comprised of carpet, back coating or its alternatives and, if necessary, a second or more backing layers. The carpet may be comprised of a pile layer and a primary backing layer.

Other automotive applications of tufted carpets may include optional floor mats or other interior trim parts.

The trim or mat construction may differ in structure and design to meet the requirements of a particular application. The construction may be comprised of a tufted carpet including a pile layer and a primary backing layer, a back coating and one or more additional layers adapted to the specific requirements of the application. The most challenging requirements may be associated with tufted carpets used in vehicle floor systems.

Independent of the application, the tufted carpet with its pile layer, is principally comprised of two different types of carpet surface construction. These constructions may include cut pile or loop pile layers. Tufted carpets generally include a composite structure, having a primary backing layer in which tufts of carpet yarn are introduced. The tufts may form the pile layer. The primary backing layer may be comprised of a nonwoven or woven material of polyamide, polyester, polyolefin or cotton or mixtures of aforementioned polymers. Typically nonwoven primary backing layers are formed by spunbonding.

After the tufting process, a back coating can then be applied to the underside of the carpet construction in order to securely retain the tufted material in the primary backing layer. It may be beneficial, in terms of recycling, to choose the same type of synthetic material for each of the tufts and the primary backing layer. The back coating may, for example, be comprised of latex. Alternatively, synthetic materials other than latex may be applied by extrusion to the underside of the carpet construction. Also, the tufted material may be secured in the primary backing layer by a thermal process in which the tufts and the primary backing layer are melted together.

Carpet yarn used in tufted carpets for automotive applications is typically a manmade yarn consisting of polyamide, polyester or polyolefin. These yarns may include BCF yarns (Bulked Continuous Filament yarns) comprising a specific number of single filaments. BCF yarns are bundles of filaments that have been melt spun, drafted and textured. The most common BCF yarn that is used as carpet yarn in automotive applications is polyamide (PA). Further advances in technology have lead to alternative yarns such as, for example, polyethylene terephthalate (PET) yarns and polypropylene (PP) yarns.

The dominant design limitation in vehicle carpeting is cost. The quality of tufted carpets may be assessed in terms of abrasion, stress whitening and weight. Other terms of quality may include cleanability, aesthetics, haptics and recyclability of used materials.

Improvements in carpet technology may require balancing abrasion properties and weight in order to optimize cost. To meet standard abrasion specifications, a certain weight of material is needed to construct a tufted carpet. Abrasion can be tested according to the DIN 53 754 (German Industrial Standard). This procedure may determine the wear resistance of trim materials by means of a rotary platform which supports a sample and multiple rotating abrasion wheels. The rotating wheels are pressed onto the rotating pile layer of the sample. After a certain number of revolutions, the loss of weight of the sample is measured and the visual appearance of the sample is assessed. The loss of weight may indicate the wear resistance or Taber abrasion, named after the test apparatus of Taber Industries. Another effect caused by the Taber test is the stress whitening of the sample. Due to the stress whitening of the sample, the physical or visual appearance is changed. The appearance change may be caused by a change of the reflection of light in the sample caused by mechanical damage of the filaments due to abrasion.

Due to abrasion specifications, applications using PP yarn require increased material weight compared to those applications using PA yarn. On the other hand, tufted carpets of PP yarn feature a higher stain resistance compared to tufted carpets of PA yarn; cleanability being an important property of a carpet to be used in vehicles.

PET yarn results in carpeting that is less durable than PA carpeting, and is only recommended for light to moderate wear conditions. PET yarn, however, has a natural stain resistance quality. As such, PET yarn does not require the application of stain resistance chemicals required by PA yarns.

### SUMMARY

It is the object of exemplary embodiments of the invention to create a carpet with high stain resistance made of polypropylene (PP) yarn or polyethylene terephthalate (PET) yarn that features an improved abrasion resistance without increasing the weight of the carpet or the cost of manufacturing.

One embodiment of the invention is directed to a tufted carpet which may be used for sound attenuation in a passenger cabin of a vehicle. The tufted carpet may include at least one primary backing layer connected to a Body-In-White via one or more additional layers. The at least one primary backing layer may further be connected to a pile layer. The pile layer may have a bulked continuous filament (BCF) yarn. The BCF yarn may include at least one yarn material chosen from (i) polypropylene (PP) yarn material with a tenacity between about 2.6 cN/dtex and about 3.2 cN/dtex at an elongation of about 50% to about 70%, and (ii) a polyethylene terephthalate (PET) yarn material with a tenacity between about 2.6 cN/dtex to about 3.4 cN/dtex at an elongation of about 20% to about 40%.

In various embodiments, the tufted carpet may include one or more of the following additional features: wherein the BCF yarn includes a predetermined number of filaments, wherein each of the predetermined number of filaments has a predetermined diameter of about 5 to about 20 dpf; wherein the predetermined number of filaments is between about 70 to about 150 filaments; wherein the BCF yarn includes PP yarn material having between about 120 to about 150 filaments; wherein the BCF yarn includes PET yarn material having between about 70 to about 100 filaments; wherein the BCF yarn includes trilobal filaments; wherein the pile layer has a pile weight between about 200 gsm and about 750 gsm; wherein the carpet is a piece dyed carpet; wherein the BCF yarn is a solution dyed BCF yarn; wherein the at least one primary backing layer and the BCF yarn either both include a PP material or both include a PET material; one or more additional layers, and wherein each of the one or more additional layers includes the same material as the BCF yarn and the at least one primary backing layer, and is attached to an underside of the carpet.

A further embodiment of the invention is directed to a method of producing a tufted carpet. The method may include tufting a Bulk Continuous Filament (BCF) yarn to form tufts. The BCF yarn may include at least one yarn material chosen from (i) polypropylene (PP) yarn material with a tenacity between about 2.6 cN/dtex and about 3.2 cN/dtex at an elongation of about 50% to about 70%, and (ii) a polyethylene terephthalate (PET) yarn material with a tenacity between about 2.6 cN/dtex to about 3.4 cN/dtex at an elongation of about 20% to about 40%. The tufting may include tufting at a gauge of 5/64th inch onto a primary backing layer. The method may further include applying a back coating to the tufted carpet via an extrusion, a latex application, or a thermal process to secure the tufted yarn to the primary backing layer.

In various embodiments, the method may include one or more of the following additional features: piece dying the tufted carpet; wherein applying the back coating includes applying a back coating comprised of the same material as the tufts; and wherein the BCF yarn and the back coating are each comprised of about 20% to about 80% recycled postindustrial waste.

A further embodiment of the invention is directed to a tufted carpet. The tufted carpet may include a Bulk Continued Filament (BCF) yarn. The BCF yarn may include a plurality of filaments and a yarn material. The material may be at least one of a (I) polypropylene (PP) yarn material with a tenacity between about 2.6 cN/dtex and about 3.2 cN/dtex at an elongation of about 50% to about 70% and having about 120 to about 150 filaments, and (II) a polyethylene terephthalate (PET) yarn material with a tenacity between about 2.6 cN/dtex to about 3.4 cN/dtex at an elongation of about 20% to about 40% and about 70 to about 100 filaments.

In various embodiments, the tufted carpet may include one or more of the following additional features: wherein each of the plurality of filaments includes a diameter of about 5 to about 20 dpf; wherein the plurality of filaments include trilobal filaments; wherein the BCF yarn includes a weight between about 200 gsm and about 750 gsm; and wherein the carpet is a piece dyed carpet.

### BRIEF DESCRIPTION OF THE DRAWINGS

The accompanying drawings, which are incorporated in and constitute a part of this specification, illustrate embodiments of the invention and together with the description, serve to explain the principles of the present disclosure. In the drawings:

FIG. 1 is a schematic cross-sectional view of a vehicle floor system; and

FIG. 2 is a schematic cross-sectional view of a tufted cut pile carpet in accordance with the present invention.

### DETAILED DESCRIPTION

A tufted carpet, according to an exemplary embodiment of the disclosure, may include a pile layer and at least one primary backing layer. The pile layer may have a pile weight and may be comprised of a bulked continuous filament (BCF) yarn. The BCF yarn may be comprised of a predetermined number of filaments having a predetermined diameter. The BCF yarn may consist of a polypropylene (PP) yarn with a tenacity between about 2.6 cN/dtex (centinewton per decitex) and about 3.2 cN/dtex at an elongation of about 50% to about 70%, or polyethylene terephthalate (PET) with a tenacity between about 2.6 cN/dtex to about 3.4 cN/dtex at an elongation of about 20% to about 40%.

Research on different types of carpets and a wide variety of BCF yarns has shown, that the wear resistance of carpets for automotive applications depends on physical properties of the BCF yarn as well as its material. One of those physical properties may include the tenacity of the yarn. To reach a predetermined tenacity, the yarn may be drawn to a certain extent. The more the filaments of yarn are drawn, the higher the tenacity becomes. As there is a limit to draw ratio, drawing the yarn after a certain point will result in filament breakage. Previously, it was believed that higher tenacity is not required to improve the abrasion resistance performance, and moreover, may create running problems during production of yarn. Therefore, BCF PP yarn and BCF PET yarns were manufactured at optimum level tenacity to have good running performance (no filament breakage). Contrary to the prior art, however, it has been found that an enhancement of tenacity with PP or PET yarn without increasing filament breakage (having the same running performance), may result in an increase of abrasion resistance in carpets. For example, it has been found that PP yarn or PET yarn may have an improved abrasion resistance when they are produced in a high tenacity area. Therefore, it is possible to combine the advantages of PET yarns or PP yarns over PA yarns in stain resistance with an improved wear resistance by increasing the tenacity.

In reference to abrasion resistance of tufted carpet, the best results may be obtained with the use of a BCF PP yarn with a tenacity of about 2.6 cN/dtex (centinewton per decitex) to about 3.2 cN/dtex at an elongation of about 50% to about 70%. Preferably the tenacity of the used PP yarn is in the range of about 2.8 cN/dtex (centinewton per decitex) to about 3.1 cN/dtex at an elongation of about 50% to about 65%. Surprisingly this behavior applies to BCF PET yarn as well. In reference to abrasion resistance of the tufted carpet, best results may be obtained with the use of a BCF PET yarn with a tenacity of about 2.6 cN/dtex (centinewton per decitex) to about 3.4 cN/dtex at an elongation of about 20% to about 40%. Preferably the tenacity of the used PET yarn is in the range of about 2.8 cN/dtex (centinewton per decitex) to about 3.2 cN/dtex at an elongation of about 25% to about 35%.

In order to reduce the weight of the carpet, the diameter of each filament is reduced. For example, the diameter of each filament may be in the range of about 5 to about 20 dpf (decitex per filament) for either PP yarn or PET yarn. Preferably the PP yarn used to manufacture the tufted carpet has a diameter of about 6 to about 12 dpf. Best results for PP yarn having the specified tenacity in abrasion performance may be achieved with a filament diameter of about 7 dpf. Preferably the PET yarn used to manufacture the tufted carpet has a diameter of about 10 to about 20 dpf. Best results for PET yarn having the specified tenacity in abrasion performance may be achieved with a filament diameter of about 15 dpf. The modification ratio should preferably be close to one in order to have a high uniformity in filament diameter. For BCF yarn, the modification ratio may be between about 0.9 and about 1.1.

To achieve an abrasion performance comparable to that of commonly used carpet fibers such as PA, less material may be used by manufacturing carpets of fine dpf PP yarn, or equal to less material may be used by manufacturing carpets of fine dpf PET yarn. The PP yarn may comprise about 120 to about 150 filaments, preferably about 130 to about 140 filaments. The best ratio in weight to performance may be achieved with a PP yarn of about 135 filaments. The PET yarn may comprise about 70 to about 100 filaments, preferably about 75 to about 90 filaments. The best ratio in weight to performance may be achieved with a PET yarn of about 80 filaments.

The number of filaments per square meter may also influence haptics or touch of tufted carpets. For example, haptics may be enhanced by a higher number of filaments.

Abrasion tests in accordance to the standard DIN 53754 have shown that carpets of exemplary embodiments of the invention may have comparable wear resistance to known carpets made of PA yarn. For example, wear properties of the pile layer in accordance to the present invention are superior to tufted carpets of PP yarn or PET yarn known in the art, due to the increase in tenacity.

Both PP filaments and PET filaments may be manufactured in a variety of different cross sectional shapes including, for example, circular, rectangular, polygonal or other types of cross sectional shapes, as well as hollow or core and sheath filaments. BCF yarns of PP or PET may also consist of filaments of the trilobal type according to embodiments of the present invention.

The pile weight of tufted carpets according to embodiments of the invention may be about 200 gsm (grams per square meter) to about 750 gsm, depending on the application. For instance, the pile weight of a carpet with PP yarn or PET yarn according to embodiments of the invention and used in a vehicle floor system having the highest standards of abrasion, may be in the range of about 250 gsm to about 450 gsm. Compared to manmade fibers used in tufted carpets other than PP or PET, the low weight may lessen important environmental concerns of automotive applications of tufted carpets. The BCF yarn and primary backing layer used in a carpet according to embodiments of the invention, may be made of about 20% to about 80% of recycled postindustrial waste.

One type of dyeing of carpets in automotive applications is piece dyeing. In piece dyeing the carpet is produced in a white color and dyed after the tufting process but before the application of the back coating. Alternatively, a BCF yarn that is solution dyed may be used. Solution dyeing has an advantage in manufacturing in that the tufted carpet is ready to use after tufting. PP yarns are advantageously solution dyed yarns, whereas carpets made of PET yarns are commonly piece dyed carpets.

In manufacturing process the tufting gauge is preferably selected at 5/64th inch for the finer PP yarn, in order to achieve the optical and haptic properties. In the case of PET yarn, either 5/64th inch or 1/10th inch gauge are preferred. The selection of the tufting gauge also influences the stress whitening. For example, the more filaments per square meter the less stress whitening that appears when the carpet is brought in shape due to the profile of the floor or trim. Common tufting gauges that may also be used for either polymer are ⅛th inch, 5/32nd inch and 1/10th inch. It is to be understood that both the foregoing general description and the following detailed description are exemplary and explanatory only and are not restrictive of the invention, as claimed.

The present invention relates generally to floor systems, deck side trims in trunks, optional mats or other interior trim parts in vehicles and more particularly, tufted PP carpets or tufted PET carpets and methods of producing the same.

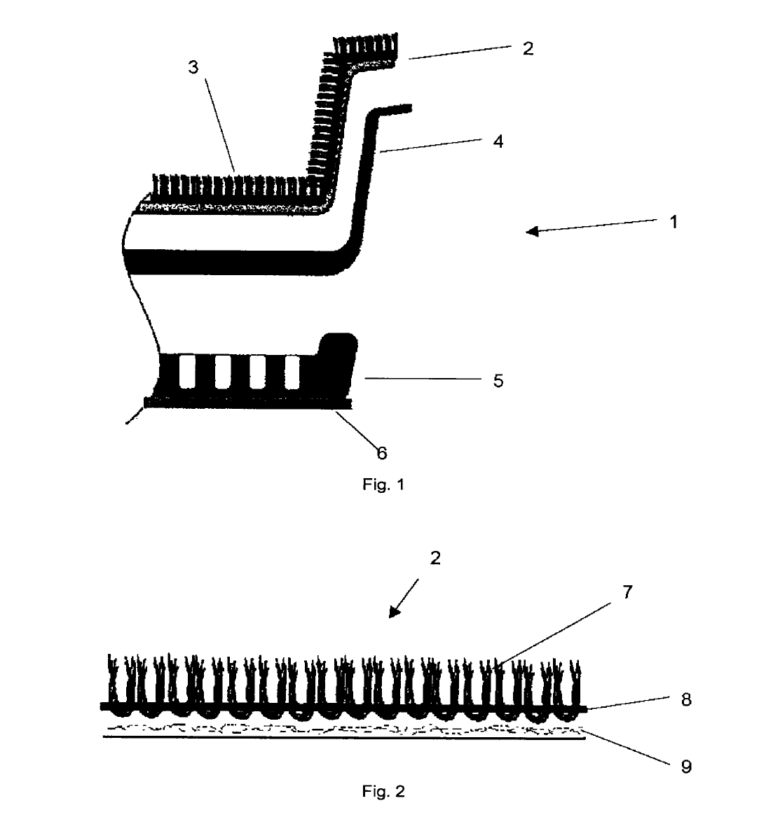

Referring to FIG. 1, an embodiment of a floor system 1 in accordance with the known prior art is shown. A vehicle floor system 1 may comprise three main elements, first a carpet 2 with a decorative top layer 3 of fiber, second a substrate 4 and third a decoupler 5 with acoustic and vibration damping layers. The decoupler 5 is the layer that is in contact with the body-in-white (BIW), such as the bodywork 6 of the vehicle. The decoupler is generally comprised of foam and fibrous material.

The substrate 4 may be an absorber or a barrier and may be comprised of a combination of materials, fibers and foams to form a controlled porosity substrate.

The carpet 2 may be formed of two layers, the pile layer and the primary backing layer. The decorative top layer 3 may be formed of the tufted yarn and comprise the pile layer. The tufts may be stitched into the primary backing layer. The primary backing layer may be formed of a woven or nonwoven material. The pile layer and the primary backing layer may collectively comprise the carpet, whereas the back coating may comprise the intersectional layer to the substrate 4. Generally the pile layer and the primary backing layer comprise the carpet.

Referring to FIG. 2, a tufted cut pile carpet 2 in accordance with an exemplary embodiment of the present invention is shown. The construction of cut and loop pile carpet 2 is the same as shown in FIG. 1 except for the character of the tufts 7. The tufted carpet comprises the tufts 7 that are introduced into the primary backing layer 8. The tufts are then cut open on the upper side of the carpet 2. The pile layer 7 and the primary backing layer 8 thus comprise the tufted carpet according to an embodiment of the invention. There are several known methods to lock the tufts 7 in their position in the primary backing layer 8. For instance a back coating 9 may be disposed adjacent to the primary backing layer 8 in order to retain the tufts 7 in the primary backing layer 8. Alternatively, the tufts 7 and the primary backing layer may be melted together on the underside of the carpet. Depending on the position in the floor system or automotive application and the intended function of the carpet 2, a third or more backing layers may be disposed adjacent to the back coating 9.

The tufts 7 may comprise the pile layer that is seen and felt by the user of the vehicle. The pile layer may consist of tufted PP or PET yarn comprising a predetermined number of filaments. Because of the fine filaments, the weight per square meter of a carpet in accordance to the present invention does not exceed the weight of a carpet manufactured as known in the art.

Other embodiments will be apparent to those skilled in the art from consideration of the specification and practice of the disclosed method and apparatus. It is intended that the specification and examples be considered as exemplary only, with a true scope and spirit of the invention being indicated by the following claims.

1-15. (canceled)

16. A tufted carpet used for sound attenuation in a passenger cabin of a vehicle, the tufted carpet comprising:
a pile layer configured to be coupled to the cabin via one or more other layers, the pile layer having a bulked continuous filament (BCF) yarn;
wherein the BCF yarn includes at least a polypropylene (PP) yarn material with a tenacity between about 2.6 cN/dtex and about 3.2 cN/dtex at an elongation of about 50% to about 70%.

17. The carpet of claim 16, wherein the BCF yarn includes a predetermined number of filaments, wherein each of the predetermined number of filaments has a predetermined diameter of about 5 to about 20 dpf.

18. The carpet of claim 17, wherein the predetermined number of filaments is between about 70 to about 150 filaments.

19. The carpet of claim 18, wherein the BCF yarn includes PP yarn material having between about 120 to about 150 filaments.

20. The carpet of claim 16, wherein the BCF yarn includes trilobal filaments.

21. The carpet of claim 16, wherein the pile layer has a pile weight between about 200 gsm and about 750 gsm.

22. The carpet of claim 16, wherein the carpet is a piece dyed carpet.

23. The carpet of claim 16, wherein the BCF yarn is a solution dyed BCF yarn.

24. The carpet of claim 16, wherein the at least one primary backing layer and the BCF yarn either both a PP material.

25. The carpet of claim 24, further comprising:
one or more additional layers, wherein each of the one or more additional layers includes the same material as the BCF yarn and the at least one primary backing layer, and is attached to an underside of the carpet.

26. A method of producing a tufted carpet, comprising:
tufting a Bulk Continuous Filament (BCF) yarn to form tufts, the BCF yarn including at least a polypropylene (PP) yarn material with a tenacity between about 2.6 cN/dtex and about 3.2 cN/dtex at an elongation of about 50% to about 70%;
wherein the tufting includes tufting at a gauge of 5/64th inch onto a primary backing layer; and
applying a back coating to the tufted carpet via an extrusion, a latex application, or a thermal process to secure the tufted yarn to the primary backing layer.

27. The method of claim 26, further including piece dying the tufted carpet.

28. The method of claim 26, wherein applying the back coating includes applying a back coating comprised of the same material as the tufts.

29. The method claim 26, wherein the BCF yarn and the back coating are each comprised of about 20% to about 80% recycled postindustrial waste.

30. A tufted carpet, comprising:
a bulked continuous filament (BCF) yarn, the BCF yarn including a plurality of filaments and a yarn material, wherein the material is a polypropylene (PP) yarn material with a tenacity between about 2.6 cN/dtex and about 3.2 cN/dtex at an elongation of about 50% to about 70% and having about 120 to about 150 filaments.

31. The carpet of claim 30, wherein each of the plurality of filaments includes a diameter of about 5 to about 20 dpf.

32. The carpet of claim 30, wherein the plurality of filaments include trilobal filaments.

33. The carpet of claim 30, wherein the BCF yarn includes a predetermined number of filaments and the predetermined number of filaments is between about 70 to about 150 filaments.

34. The carpet of claim 30, wherein the BCF yarn includes a weight between about 200 gsm and about 750 gsm.

35. The carpet of claim 30, wherein the carpet is a piece dyed carpet.
